(19) United States
(12) Patent Application Publication
(10) Pub. No.: US 2020/0034699 A1
(43) Pub. Date: Jan. 30, 2020

(54) ACCELERATING APPRATUS OF NEURAL NETWORK AND OPERATING METHOD THEREOF

(71) Applicant: SK hynix Inc., Gyeonggi-do (KR)

(72) Inventors: Jae Hyeok JANG, Gyeonggi-do (KR); Joo Young KIM, Gyeonggi-do (KR); Eui Cheol LIM, Gyeonggi-do (KR)

(21) Appl. No.: 16/519,643

(22) Filed: Jul. 23, 2019

(30) Foreign Application Priority Data
Jul. 24, 2018 (KR) 10-2018-0086212
Jul. 15, 2019 (KR) 10-2019-0085326

(51) Int. Cl. G06N 3/063; G06F 7/544

(52) U.S. Cl. CPC G06N 3/063; G06F 7/5443

(57) ABSTRACT

An accelerating apparatus for a neural network may include: an input processor configured to decide a computation mode according to precision of an input signal, and change or maintain the precision of the input signal according to the decided computation mode; and a computation circuit configured to receive the input signal from the input processor, perform select one or more operations among multiple operations including a multiplication based on the input signal, boundary migration to rearrange multiple signals divided from the input signal, and an addition of the input signal subjected to the boundary migration, according to the computation mode, and perform the selected one or more operations on the input signal.

### CROSS-REFERENCES TO RELATED APPLICATION

The present application claims priority under 35 U.S.C. § 119(a) to Korean application number 10-2018-0086212, filed on Jul. 24, 2018 and to Korean application number 10-2019-0085326, filed on Jul. 15, 2019, which are incorporated herein by reference in their entirety.

### BACKGROUND

### 1. Technical Field

Various embodiments generally relate to an accelerating apparatus for a neural network and an operating method thereof.

### 2. Related Art

An artificial intelligence (AI) accelerator may be implemented in hardware for applications such as multi-layer perceptron (MLP) and convolutional neural network (CNN), which have been processed through software. Thus, the performance of related computation may be maximized and a computation and resource burden of a host may be reduced.

The AI accelerator mainly performs a convolution operation through a multiplication and accumulation (MAC) component. Recently, due to positive effects of mixed-precision computation and related computation of the MAC component, the number of applications to support the mixed-precision mode is increasing.

For example, when a low-precision computation (for example, INT8) is supported by a multiplier to support a relatively high-precision computation (for example, INT16 multiplier), only some bits are used for the computation. Therefore, resource waste may occur. On the other hand, when a high-precision computation is performed by only a low-precision multiplier, additional latency may occur. Thus, it may be slightly difficult to support the high-precision computation in the same clock cycle. Furthermore, when a computation component (e.g., multiplier-accumulator (MAC)) to support the low-precision mode and the high-precision mode is implemented, the size of an accumulator for accumulating result values of multiplications also needs to be considered. When the word length of a multiplicand is increased from the low-precision mode to high-precision mode, related logic may not be efficiently used because a multiplier and an adder have different increases in bit-width.

### SUMMARY

Various embodiments are directed to an accelerating apparatus for a neural network having an enhanced computation ability and an operating method thereof.

In an embodiment, an accelerating apparatus for a neural network may include: an input processor configured to decide a computation mode according to precision of an input signal, and change or maintain the precision of the input signal according to the decided computation mode; and a computation circuit configured to receive the input signal from the input processor, perform select one or more operations among multiple operations including a multiplication based on the input signal, boundary migration to rearrange multiple signals divided from the input signal, and an addition of the input signal subjected to the boundary migration, according to the computation mode, and perform the selected one or more operations on the input signal.

In an embodiment, an operating method of an accelerating apparatus for a neural network may include the steps of: deciding a computation mode according to precision of an input signal; changing or maintaining the precision of the input signal according to the decided computation mode; selecting one or more operations among multiple operations including a multiplication based on the input signal, boundary migration to rearrange multiple signals divided from the input signal, and an addition of the input signal subjected to the boundary migration, according to the computation mode; and performing the one or more selected operations on the changed input signals.

In an embodiment, an apparatus for a neural network may include: an input processor suitable for receiving an input signal corresponding to an n×n lattice, and processing the input signal to generate multiple signals respectively corresponding to (n/2)×(n/2) sub lattices of the n×n lattice; and a computation circuit suitable for performing a lattice multiplication on each of the multiple signals, and performing migration on multiplication results thereof to generate a multiplication result corresponding to the input signal.

### BRIEF DESCRIPTION OF THE DRAWINGS

FIG. 1 is a diagram illustrating a configuration of an accelerating apparatus for a neural network in accordance with an embodiment.

FIG. 2 is a diagram illustrating a detailed configuration of a computation processor in accordance with an embodiment.

FIGS. 3 and 4 are diagrams illustrating a lattice multiplication method in accordance with an embodiment.

FIGS. 5 to 9 are diagrams illustrating an INT8 lattice multiplication method using an INTO lattice.

FIG. 10 is a diagram illustrating a configuration of a computation circuit in accordance with an embodiment.

FIG. 11 is a flowchart illustrating an operating method of an accelerating apparatus for a neural network in accordance with an embodiment.

FIG. 12 is a flowchart illustrating a method for changing precision in FIG. 11 in detail.

### DETAILED DESCRIPTION

A neural network accelerating apparatus and an operating method thereof according to the present disclosure are described below with reference to the accompanying drawings through various embodiments. Throughout the specification, reference to “an embodiment” or the like is not necessarily to only one embodiment, and different references to any such term are not necessarily to the same embodiment(s).

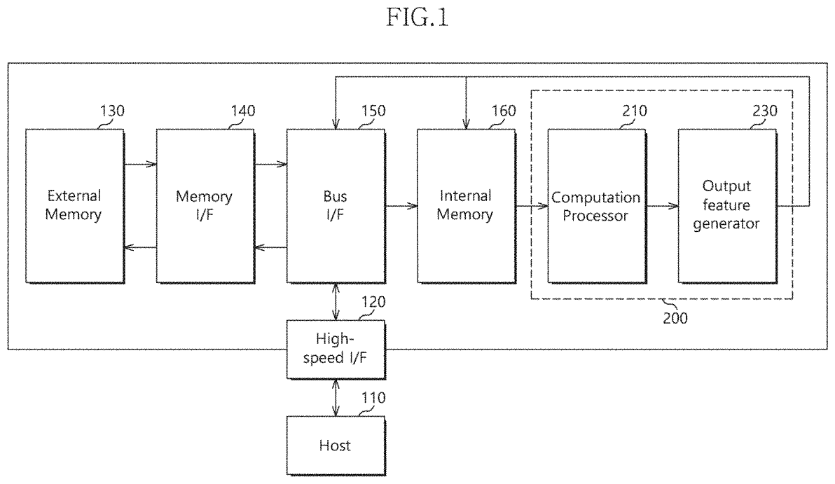

FIG. 1 is a diagram illustrating a configuration of an accelerating apparatus 200 for a neural network in accordance with an embodiment.

Referring to FIG. 1, the accelerating apparatus 200 may serve to support a host 110, and include a computation processor 210 and an output feature generator 230. The computation processor 210 may receive an input signal from an internal memory 160 according to a signal, which is transferred through a high-speed interface (I/F) 120 from the host 110, and perform a computation on the received signal. The output feature generator 230 may receive a computation result, which may be a value, from the computation processor 210 and output the computation result. The input signal may include a feature and a weight, but the present invention is not limited thereto.

The signal from the host 110 may be transferred to the accelerating apparatus 200 through an external memory 130, a memory interface (I/F) 140, a bus interface (I/F) 150 and the internal memory 160. Alternatively, the signal from the host 110 may be transferred to the accelerating apparatus 200 through the high-speed I/F 120, the bus I/F 150 and the internal memory 160. Even when the signal from the host 110 is routed through and stored in the external memory 130, the signal is first transferred through the high-speed I/F 120 and the bus I/F 150.

The external memory 130 may be implemented as a dynamic random access memory (DRAM), and the internal memory 160 may be implemented as a static random access memory (SRAM), but the present invention is not limited thereto. The high-speed I/F 120 may be implemented as peripheral component interconnect express (PCIe), but the present invention is not limited thereto.

The computation processor 210 may serve to support a computation on various bits. The computation processor 210 may decide a computation mode for each level of precision, and change and apply computation rules by sharing resources within the computation processor 210 according to the decided computation mode.

For example, the computation processor 210 may share resources such as an accumulator and a flip-flop, and apply various computation rules depending on the computation mode. This configuration is described below in more detail.

The output feature generator 230 may receive the computation result value from the computation processor 210. Further, the output feature generator 230 may convert the computation result value into a non-linear value by applying an activation function to the result value. Furthermore, the output feature generator 230 may pool the non-linear value, and transfer the pooled value to the internal memory 160 or the host 110 through the bus I/F 150 and the high-speed I/F 120. The present invention is not limited to the configuration in which the output feature generator 230 transfers the computation result value to the internal memory 160 or the host 110; the computation result value may be transferred to another component, if necessary.

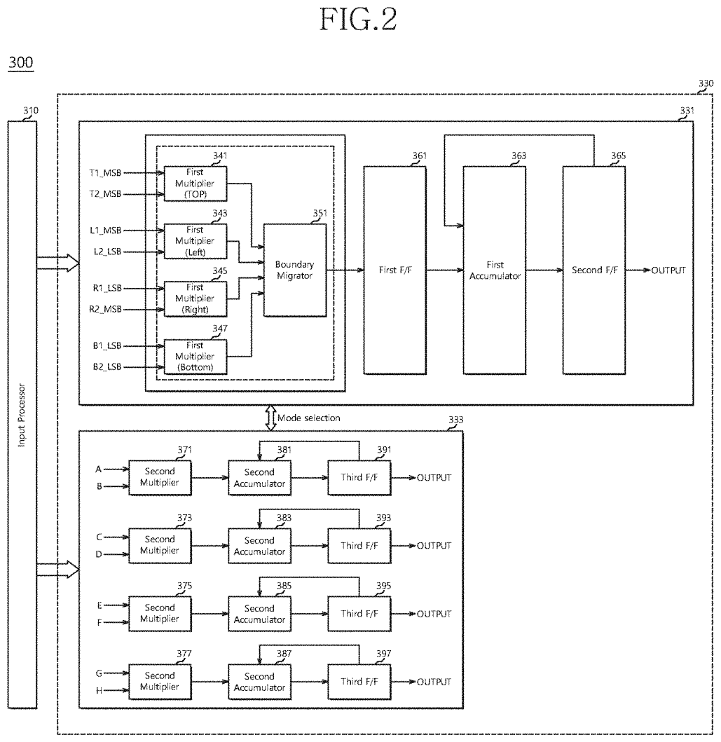

FIG. 2 is a diagram illustrating a detailed configuration of a computation processor 300 in accordance with an embodiment. The computation processor 300 may correspond to the computation processor 210 of FIG. 1.

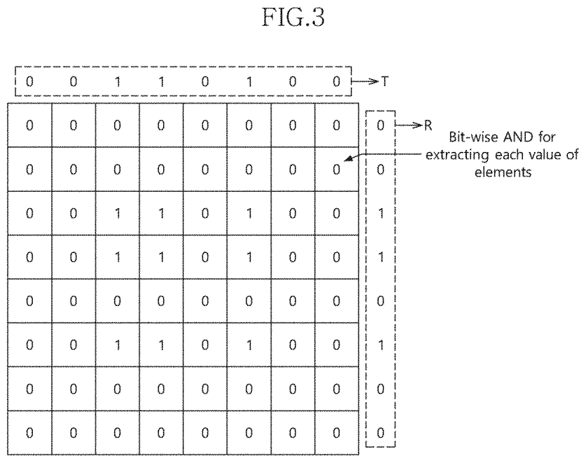

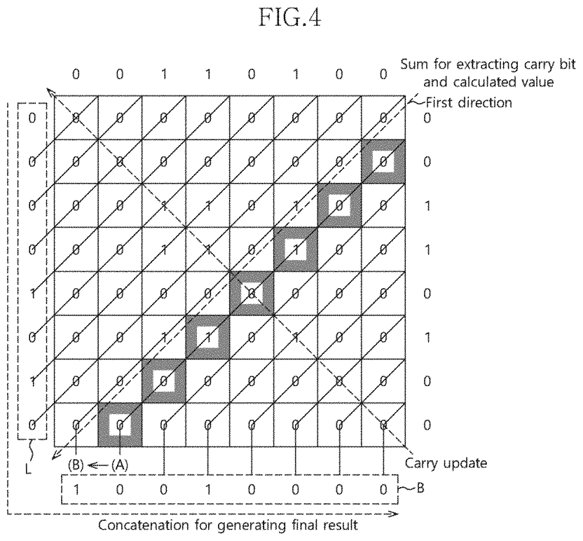

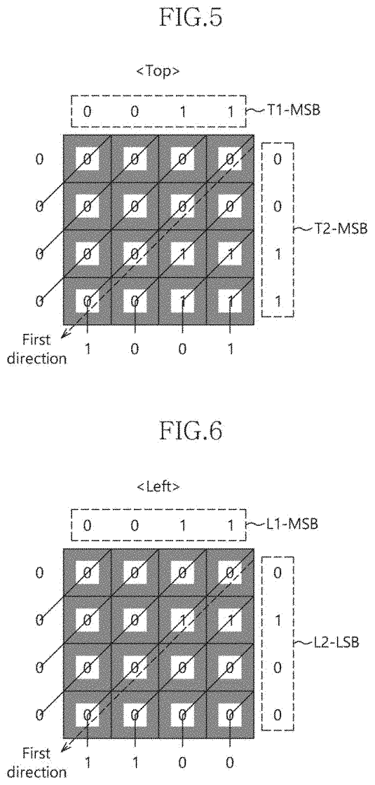

Configuration of the computation processor is described with reference to FIGS. 3, 4 and 5 to 9. FIGS. 3 and 4 are diagrams illustrating a lattice multiplication method in accordance with an embodiment. FIGS. 5 to 9 are diagrams illustrating an INT8 lattice multiplication method using an INTO lattice.

Referring to FIG. 2, the computation processor 300 may include an input processor 310 and a computation circuit 330.

The input processor 310 may decide a computation mode according to the precision of an input signal. Further, the input processor 310 may change or retain the precision of the input signal according to the decided computation mode, and transfer the input signal to the computation circuit 330. Since the precision of an input signal for each computation mode is set in advance, the input processor 310 may change the precision of the current input signal when the precision of the current input signal is different from the precision of the input signal, which is matched with the decided computation mode.

For example, the input signal may include an input signal with high-precision (e.g., INT16 or 16-bit input signal), or an input signal with low-precision (e.g., INT8 or 8-bit input signal). INTx generally represents the input signal with precision x, where x may be 8, 16 or other suitable number.

The input processor 310 may change the precision of the input signal from INT8 to INT4 or from INT16 to INT8, and then transfer the changed input signal to the computation circuit 330. The input processor 310 may set the computation mode for each precision of the input signal in advance, and decide whether to change the precision of the input signal to be transferred to the computation component 300 according to the set computation mode.

When the precision does not need to be changed, the input processor 310 may maintain the form of the input signal as it is, and transfer the input signal to the computation circuit 330.

When changing the precision of the input signal, the input processor 310 may divide the input signal into multiple signals, each having a smaller number of bits than the number of bits in the input signal, depending on the computation mode of the input signal. Then, the input processor 310 may transfer the multiple signals to the computation circuit 330.

When so dividing the input signal into multiple signals, the input processor 310 may halve the current bits of the input signal and thus generate two signals each with half the number of bits as the original input signal. For example, the input processor 310 may divide an INT16 signal) into two INT8 signals.

The computation circuit 330 may select one or more rules (or operations) among multiple rules or operations including a multiplication based on the input signal, boundary migration to rearrange a plurality of groups obtained by dividing the input signal, and an addition of the input signal subjected to the boundary migration, according to the computation mode, and then perform a computation based on the selected rule.

The computation circuit 330 may perform a lattice multiplication on the input signal. Alternatively, the computation circuit 330 may perform a multiplication on the input signal based on any of Booth multiplication, Dadda multiplication and Wallace multiplication, which have a relatively small size and high speed. However, the present invention is not limited thereto.

The case in which the computation circuit 330 performs the lattice multiplication on an input signal is described as an example.

Referring to FIGS. 3 and 4, a lattice multiplication for an INT input signal (i.e., an INT8 lattice multiplication) is described.

As illustrated in FIG. 3, the computation circuit 330 may arrange 8-bit data to be computed at a first side T (for example, top) of a lattice and a bit-wise AND operation on the arranged 8-bit data. Further, the computation circuit 330 may arrange 8-bit data to be computed at a second side R (for example, right) of the lattice and a bit-wise AND operation on the arranged 8-bit data. Furthermore, the computation circuit 330 may derive all possible cases through a bit-wise AND operation. For example, all possible cases acquired through the bit-wise AND operation may range from a first column of 00000000 to an eighth column of 00000000.

Referring to FIG. 4, the computation circuit 330 may perform a bit-wise addition by reflecting a carry update in a first direction from the right bottom based on the lattice, after deriving all values (all possible cases). For example, when a carry bit occurs as indicated by (A) of FIG. 4, the input processor 310 may pass the carry bit to the next line B at the left top such that the carry bit can be reflected during the next computation. That is, a result value of (A) may become 0, and a result value of (B) to which the carry bit is passed may become 1.

When the bit-wise additions on all values within the lattice are completed, the computation circuit 330 may sequentially enumerate bits of a third side L and a fourth side B of the lattice from the left top toward the right bottom based on the lattice, thereby acquiring a final result value of the computation.

That is, the computation circuit 330 may acquire a result value of 0000_1010_1001_0000 through a lattice multiplication of 0011_0100 by 0011_0100.

The computation circuit 330 may include first and second computation circuits 331 and 333 for separately applying the computation rules according to each computation mode.

The first computation circuit 331 may include a plurality of first multipliers 341, 343, 345 and 347, a boundary migrator 351, a first flip-flop (F/F) 361, a first accumulator 363 and a second flip-flop (F/F) 365.

The first computation circuit 331 may serve to perform a computation on an input signal whose precision has been changed. For example, the first computation circuit 331 may receive a plurality of input signals T1_MSB, T2_MSB, L1_MSB, L2_LSB, R1_LSB, R2_MSB, B1_LSB and B2_LSB, which have correlation with one another. When the precision of the input signal has been changed from INT16 to INT8, a plurality of INT8 signals transferred to the first computation circuit 331 may be obtained by dividing the INT16 input signal before the change, and thus have correlation with one another.

More specifically, when the input signal whose precision has been changed is received, the plurality of first multipliers 341, 343, 345 and 347 may perform a computation on the input signal according to the lattice multiplication rule. Each of the first multipliers 341, 343, 345 and 347 may be an INT8 multiplier that performs a multiplication on an input signal with a precision of INT8. However, the present invention is not limited thereto; each of the first multipliers 341, 343, 345 and 347 can also process an input signal with another precision according to the necessity of an operator.

The first computation circuit 331 may receive an input signal whose precision has been changed from 8 to 4, from the input processor 310. As illustrated in FIGS. 5 to 8, the first computation circuit 331 may form a plurality of groups divided into 4-bit lattice structures based on a 4-bit input signal.

The input signal whose precision has been changed may be formed as a plurality of groups or multiple input signals (for example, FIGS. 5 to 8) divided into ½ bit lattice structures of the initial bit lattice structure (for example, FIGS. 3 and 4).

The first multipliers 341, 343, 345 and 347 may derive all possible cases through a bit-wise AND operation on the input signal in each of the groups. Further, the first multipliers 341, 343, 345 and 347 may perform a bit-wise addition on the lattice structures of the respective groups by reflecting a carry update in a first direction from the right bottom, thereby deriving individual lattice values.

Referring to FIGS. 5 to 8, the first multipliers 341, 343, 345 and 347 may receive the input signals of the respective groups from the input processor 310. The input processor 310 may transfer the input signals to the corresponding first multipliers 341, 343, 345 and 347 according to the positions of the input signals within the plurality of groups.

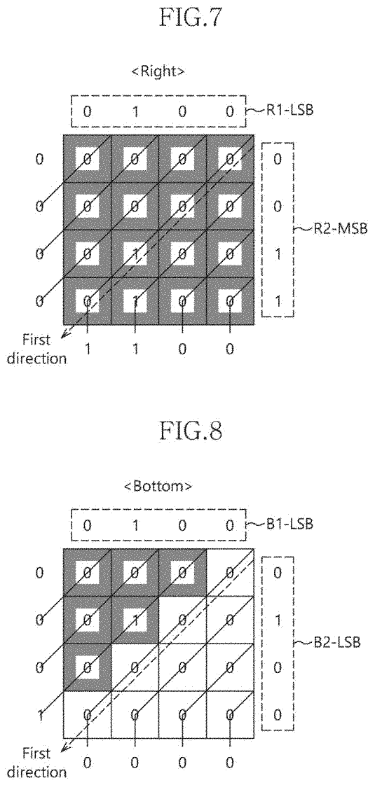

For example, the first multiplier 341 may receive a T1-MSB input signal of 0011 and a T2-MSB input signal of 0011 in FIG. 5. The first multiplier 343 may receive an L1-MSB input signal of 0011 and an L2-LSB input signal of 0100 in FIG. 6. The first multiplier 345 may receive an R1-LSB input signal of 0100 and an R2-MSB input signal of 0011 in FIG. 7. The first multiplier 347 may receive a B1-LSB input signal of 0100 and a B2-LSB input signal of 0100 in FIG. 8. The first multiplier 341 may serve to process the input signal of FIG. 5, which also corresponds to the top left of FIG. 4. The first multiplier 343 may serve to process the input signal of FIG. 6 corresponding to the bottom left of FIG. 4. The first multiplier 345 may serve to process the input signal of FIG. 7 corresponding to the top right of FIG. 4. The first multiplier 347 may serve to process the input signal of FIG. 8 corresponding to the bottom right of FIG. 4. However, the present invention is not limited thereto.

The plurality of groups (or multiple signals) of FIGS. 5 to 8 may be obtained by dividing the 8×8 lattice structure of FIG. 4 into 4×4 lattice structures and sorting the 4×4 lattice structures into quadrants (i.e., top left, bottom left, top right and bottom right) according to positions matched with the 4×4 lattice structures in the 8×8 lattice structure.

The first multiplier 341 may derive individual lattice values, that is, 0000_1001 from the group of FIG. 5. The first multiplier 343 may derive individual lattice values, that is, 0000_1100 from the group of FIG. 6. The first multiplier 345 may derive individual lattice values, that is, 0000_1100 from the group of FIG. 7. The first multiplier 347 may derive individual lattice values, that is, 0001_0000 from the group of FIG. 8. The first multipliers 341, 343, 345 and 347 may derive individual lattice values through the bit-wise AND operation and the bit-wise addition on the input signals of the respective groups.

When the first computation circuit 331 supports an INT16 computation with INT8 multipliers, a total of four INT8 multipliers within the first computation circuit 331 may be provided as the first multipliers 341, 343, 345 and 347, thereby supporting one-time throughput.

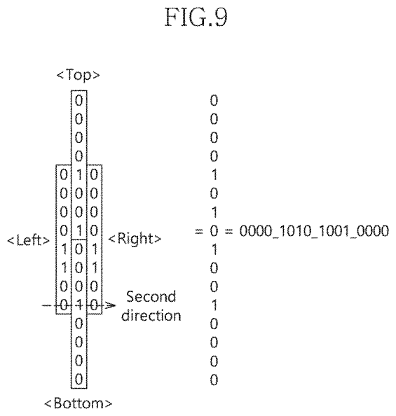

The boundary migrator 351 may perform boundary migration on the result values obtained through the computation according the lattice multiplication rule, and perform an addition to acquire a result value. The boundary migration may indicate rearranging the result values of the lattice multiplication rule as illustrated in FIG. 9, such that the final multiplication result obtained based on the input signal having the initial precision is equal to the final multiplication result obtained based on the input signal whose precision has been changed.

The boundary migrator 351 may migrate the result values received from the first multipliers 341, 343, 345 and 347 as illustrated in FIG. 9. This operation may indicate an operation for deriving a normal result value when performing a relatively high-bit multiplication (for example, INT16) using a relatively low-bit multiplier (for example, an INT8 multiplier).

Referring to FIG. 9, the boundary migrator 351 may perform boundary migration to rearrange the individual lattice values at boundary migration positions matched with the positions of the corresponding groups. The boundary migrator 351 may add the boundary migration values in a second direction, thereby deriving a result value of 0000_1010_1001_0000. The result value may coincide with the result value of FIG. 4, which has been computed based on the same input signal.

Referring back to FIG. 2, the first flip-flop 361 may perform a retiming process on the result value received from the boundary migrator 351.

Since the result value received from the boundary migrator 351 may be delayed due to a wire delay or the like, a hold time and a setup time may be changed. The hold time may be defined as the time during which data is retained. The setup time may be defined as the time at which a value of data is switched. When the number of switching operations is increased for the relatively short setup time, data setup may not be normally performed. In the present embodiment, the first flip-flop 361 may perform clock synchronization on the result value received from the boundary migrator 351 through the retiming process. Thus, the data setup may be normally performed.

The first accumulator 363 may accumulate the result value received from the first flip-flop 361. For example, the first accumulator 363 may accumulate INT16 multiplication values received from the first flip-flop 361 by continuously adding the multiplication values.

The second flip-flop 365 may store and retime the result value received from the first accumulator 363. Further, the second flip-flop 365 may perform a retiming operation on the result value and output the retimed result value. Since the retiming operation of the second flip-flop 365 is performed in the same manner as the retiming operation of the first flip-flop 361, detailed description thereof is omitted here.

The result value outputted through the second flip-flop 365 may be a result value having the initial precision before the bit conversion. For example, when the initial input value has a precision of 16, the second flip-flop 365 may output a result value having a precision of 16.

The second flip-flop 365 may output the result value to the first accumulator 363 or the output feature generator 230.

The second computation circuit 333 may include a plurality of second multipliers 371, 373, 375 and 377, a plurality of second accumulators 381, 383, 385 and 387, and a plurality of third flip-flops 391, 393, 395 and 397. The second multiplier 371, the second accumulator 381 and the third flip-flop 391 may be configured as one set. That is, the second computation circuit 333 may include four sets of multipliers, accumulators and flip-flops.

The second computation circuit 333 may serve to receive input signals having the initial precision from the input processor 310, and perform a computation on the received signals. The plurality of input signals may be independent of one another, but the present invention is not limited thereto.

When receiving the input signals from the input processor 310, the second multipliers 371, 373, 375 and 377 may acquire result values by performing a computation on the input signals according to the lattice multiplication rule.

Each of the second multipliers 371, 373, 375 and 377 may be an INT8 multiplier that performs a multiplication on input signals with a precision of 8. However, the present invention is not limited thereto; each of the second multipliers 371, 373, 375 and 377 can also process input signals with another precision according to the necessity of an operator.

When the second computation circuit 333 supports an INT8 computation with the INT8 multipliers, a total of four INT8 multipliers within the second computation circuit 333 may be provided as the second multipliers 371, 373, 375 and 377, thereby supporting quadruple throughput due to the same clock latency or reduced clock latency.

The second accumulators 381, 383, 385 and 387 may perform an addition on the result values received from the second multipliers 371, 373, 375 and 377.

The second accumulators 381, 383, 385 and 387 may share the resources of the boundary migrator 351 or the first accumulator 363. FIG. 2 illustrates each of the second accumulators 381, 383, 385 and 387 as a software block is independent of the boundary migrator 351 and the first accumulator 363. However, the second accumulators 381, 383, 385 and 387, the boundary migrator 351 and the first accumulator 363 may be implemented as one hardware block. As the computation mode is switched, each of the second accumulators 381, 383, 385 and 387 may perform an addition by sharing some of the resources of the boundary migrator 351 or the first accumulator 363. That is, each of the second accumulators 381, 383, 385 and 387 may share the resources that perform the addition function of the boundary migrator 351 and the addition function of the first accumulator 363. The switching of the computation mode may be performed by the input processor 310 of FIG. 2.

The third flip-flops 391, 393, 395 and 397 may store the result values received from the second accumulators 381, 383, 385 and 387, perform a retiming operation on the result values and output the retimed result values.

Each of the third flip-flops 391, 393, 395 and 397 may share resources of the first and second flip-flops 361 and 365. That is, each of the third flip-flops 391, 393, 395 and 397 can implement all or part of the functions of the first and second flip-flops 361 and 365.

For example, when the first computation circuit 331 implements the INT16 mode and the second computation circuit 333 implements the INT8 mode, the boundary migrator 351 of the first computation circuit 331, the adder tree of the first accumulator 363, and the first and second flip-flops 361 and 365 may be divided and implemented as the accumulators 381, 383, 385 and 387 and the flip-flops 391, 393, 395 and 397 for the respective second multipliers 371, 373, 375 and 377 of the second computation circuit 333. That is, the second computation circuit 333 may acquire the computation function, which needs to be implemented in relation to the second multipliers 371, 373, 375 and 377, from the resources of the first computation circuit 331, if necessary. This configuration is based on the characteristic that a ripple carry adder and a flip-flop chain can be separated from each other. Through the above-described method, the second accumulators 381, 383, 385 and 387 and the third flip-flops 391, 393, 395 and 397 for the four INT8 multipliers (for example, the second multipliers 371, 373, 375 and 377) may be implemented.

Therefore, the computation component to support quadruple data throughput in the INT8 computation mode may be implemented.

In the present embodiment, since the resources of the respective computation circuits and glue logic are shared, resource waste of the related logic may be minimized. Furthermore, since the multipliers have a small propagation delay value in the INT8 computation mode, an addition of output values may be immediately performed. Thus, the clock cycle for computation at the same operating frequency may be reduced by a one-clock cycle.

The computation circuit 330 of FIG. 2 may be applied to a processing element (PE) array, but the present invention is not limited thereto.

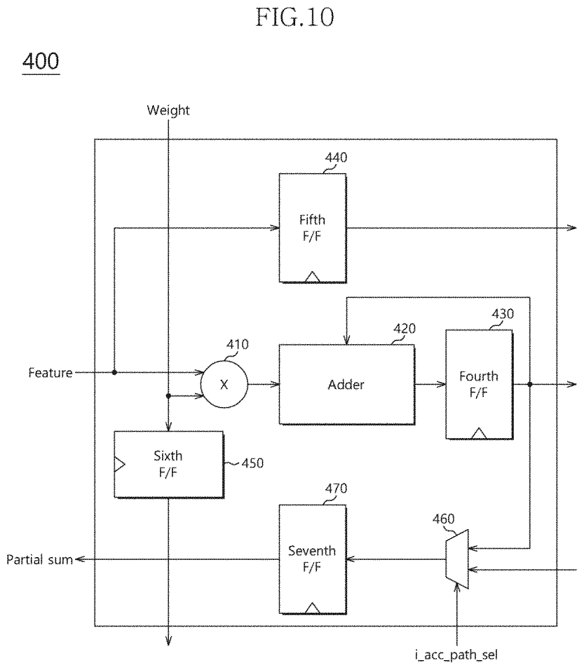

FIG. 10 is a diagram illustrating a configuration of a computation circuit 400 in accordance with an embodiment. The computation circuit 400 may replace the computation circuit 300 of FIG. 2. That is, the computation circuit 400 may be coupled to, and receive input signals from, the input processor 310 of FIG. 2.

The computation circuit 400 may be applied to a systolic array, but the present invention is not limited thereto.

The computation circuit 400 may include a third multiplier 410, an adder 420, a fourth flip-flop (F/F) 430, a fifth flip-flop 440, a sixth flip-flop 450, a multiplexer 460 and a seventh flip-flop 470.

The computation circuit 400 may receive the input signals from the input processor 310 of FIG. 2. The input signals may include a first input signal and a second input signal. In various embodiments, the first input signal may be a feature, and the second input signal may be a weight.

The third multiplier 410 may perform a lattice multiplication on the first and second input signals, and output a first result value.

The adder 420 may perform boundary migration based on the first result value received from the third multiplier 410, and then perform an addition to acquire a second result value.

Specifically, the adder 420 may perform boundary migration by rearranging groups of the first result value received from the third multiplier 410 at boundary migration positions matched with the positions of the corresponding groups. For example, the adder 420 may determine to which boundary migration positions the groups of the first result value correspond among the top, left, right and bottom of FIG. 9, and rearrange the groups of the first result value at the corresponding positions. For this operation, the boundary migration positions are matched with the positions of the groups of the first and second input signals in advance.

The adder 420 may perform a counting function and control the computation logic for the first and second input signals to be repeatedly performed a set number of times.

For example, when a computation needs to be performed on input signals with a precision of INT4, the maximum count value of the computation logic may be set to 3. For another example, when a computation needs to be performed on input signals with a precision of INT8, the maximum count value of the computation logic may be set to 7. Therefore, although each of the third multiplier 410 and the adder 420 is configured as a single component, a computation may be performed on input signals with various precisions.

The fourth flip-flop 430 may store the second result value, perform a retiming operation on the second result value and output the retimed second result value.

The fifth flip-flop 440 may transfer the first input signal Feature to a first another computation circuit (not illustrated) adjacent thereto.

The sixth flip-flop 450 may transfer the second input signal Weight to a second another computation circuit (not illustrated) adjacent thereto.

The multiplexer 460 may output any one of the second result value received from the fourth flip-flop 430 and a result value received from the first another computation circuit, in response to a signal i_acc_path_sel.

The seventh flip-flop 470 may output the result value received from the multiplexer 460.

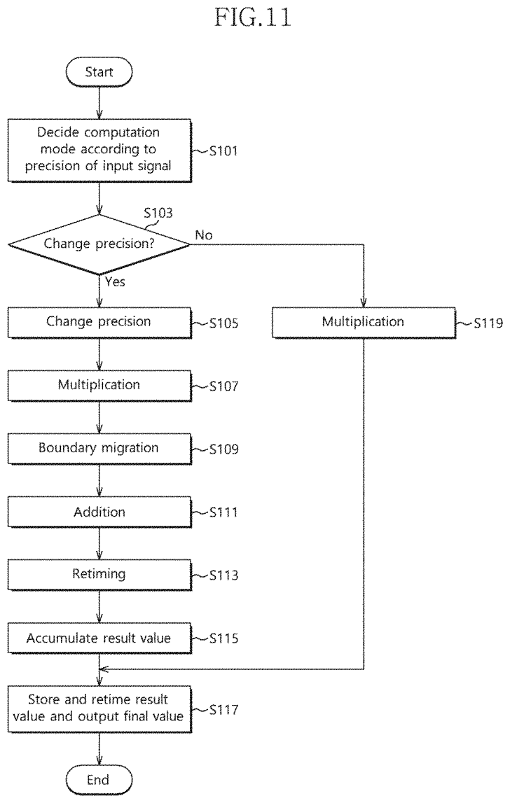

FIG. 11 is a flowchart illustrating an operating method of an accelerating apparatus for a neural network in accordance with an embodiment.

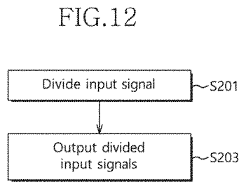

FIG. 12 is a flowchart illustrating a method for changing precision in FIG. 11 in detail.

Referring to FIG. 11, the accelerating apparatus 200 of FIG. 2 may decide a computation mode according to the precision of an input signal in step S101.

For example, the precision of the input signal may include INT16, INT8 and the like. The accelerating apparatus 200 may change or maintain the precision of the input signal according to the decided computation mode.

The accelerating apparatus 200 may check whether to change the precision of the input signal according to the computation mode in step S103.

Since the precision of an input signal for each computation mode is set in advance, the accelerating apparatus 200 may determine to change the precision of the current input signal, when the precision of the current input signal does not coincide with the precision of the input signal in the computation mode decided in step S101.

When the check result indicates that the precision of the input signal needs to be changed, the accelerating apparatus 200 may change the precision of the input signal into the precision matched with the computation mode in step S105.

More specifically, referring to FIG. 12, the accelerating apparatus 200 may divide the input signal into signals having a smaller number of bits than the number of bits in the input signal according to the computation mode of the input signal, when changing the precision of the input signal, in step S201. When dividing the input signal into signals having a smaller number of bits than the number of bits in the input signal, the accelerating apparatus 200 may halve the current bits of the input signal. The accelerating apparatus 200 may output the divided input signals in step S203.

For example, the accelerating apparatus 200 may change the precision of the input signal from INT8 to INT4 or from INT16 to INT8.

Then, the accelerating apparatus 200 may select one or more rules among a multiplication based on the input signal, boundary migration to rearrange a plurality of groups obtained by dividing the input signal, and an addition of the input signal subjected to the boundary migration, according to the computation mode, and then perform a computation based on the selected rule.

When receiving the input signal whose precision has been changed, the accelerating apparatus 200 may perform a computation on the input signal according to the lattice multiplication rule in step S107.

More specifically, the accelerating apparatus 200 may derive all possible cases through a bit-wise AND operation on the input signals of the respective groups.

Furthermore, the accelerating apparatus 200 may derive individual lattice values by performing a bit-wise addition to reflect a carry update into the lattice structures of the respective groups in the first direction from the right bottom.

For example, the accelerating apparatus 200 may derive the individual lattice values, that is, 0000_1001 from the group of FIG. 5. The accelerating apparatus 200 may derive the individual lattice values 0000_1100 from the group of FIG. 6. The accelerating apparatus 200 may derive the individual lattice values 0000_1100 from the group of FIG. 7. The accelerating apparatus 200 may derive the individual lattice values 0001_0000 from the group of FIG. 8. The accelerating apparatus 200 may derive the individual lattice values through the bit-wise AND operation and the bit-wise addition on the input signals of the respective groups. The groups shown in FIGS. 5, 6, 7 and 8 are divided from the lattice shown in FIG. 4 as previously described.

The accelerating apparatus 200 may perform a multiplication on the input signals, using any one rule of Booth multiplication, Dadda multiplication and Wallace multiplication other than the lattice multiplication.

Then, the accelerating apparatus 200 may acquire a result value by performing boundary migration and then performing an addition.

Specifically, the accelerating apparatus 200 may perform the boundary migration by rearranging the individual lattice values derived in step S107 at boundary migration positions matched with the positions of the corresponding groups, in step S109.

The accelerating apparatus 200 may derive the result value by adding the boundary migration values in the second direction in step S111.

In step S113, the accelerating apparatus 200 may perform a retiming operation on the result value derived in step S111.

In step S115, the accelerating apparatus 200 may accumulate the retimed result value in step S113.

In step S117, the accelerating apparatus 200 may store the result value, perform a retiming operation on the result value and output the retimed result value.

The result value in step S117 may have the initial precision before the bit conversion. For example, when the initial input value is a precision of INT16, the accelerating apparatus 200 may output a result value having a precision of INT16.

When the check result of step S103 indicates that the precision of the input signal needs to be retained, the accelerating apparatus 200 may acquire a result value by performing a computation on the input signal according to the lattice multiplication rule, in the case that the input signal is received, in step S119. Then, the accelerating apparatus 200 may perform step S117.

As described above, the accelerating apparatus in accordance with the embodiments may compute data having higher precision through the operation structure for data having low precision, and make the most of the resources for related operation. Furthermore, since the adder may be commonly used for each computation mode, the utilization of hardware may be maximized during artificial neural network computation.

In accordance with embodiments, the accelerating apparatus may perform a computation process for various precisions by utilizing the lattice operation and the resource sharing method. Thus, the accelerating apparatus thereof may perform a computation more efficiently, thereby improving throughput.

While various embodiments have been illustrated and described, it will be understood to those skilled in the art in light of the present disclosure that the embodiments described are examples only. Accordingly, the present invention is not limited by or to the described embodiments. Rather, the present invention encompasses all modifications and variations of any of the disclosed embodiments to the extent they fall within the scope of the claims and their equivalents.

1. An accelerating apparatus for a neural network comprising:
an input processor configured to decide a computation mode according to precision of an input signal, and change or maintain the precision of the input signal according to the decided computation mode; and
a computation circuit configured to receive the input signal from the input processor, perform select one or more operations among multiple operations including a multiplication based on the input signal, boundary migration to rearrange multiple signals divided from the input signal, and an addition of the input signal subjected to the boundary migration, according to the computation mode, and perform the selected one or more operations on the input signal.

2. The accelerating apparatus according to claim 1, wherein, in changing the precision of the input signal, the input processor divides the input signal into the multiple signals, each having a smaller number of bits than the number of bits in the input signal according to the computation mode, and transfers the multiple signals to the computation circuit.

3. The accelerating apparatus according to claim 2, wherein, in dividing the input signal, the input processor divides bits of the input signal in half.

4. The accelerating apparatus according to claim 2, wherein the computation circuit comprises a first computation circuit comprising:
a plurality of first multipliers configured to perform a computation on the multiple signals whose precisions have been changed, according to a lattice multiplication rule; and
a boundary migrator configured to perform the boundary migration and an addition on an output value of the plurality of first multipliers.

5. The accelerating apparatus according to claim 4, wherein the first multipliers perform a bit-wise AND operation on the multiple signals, and generate individual lattice values for each of the multiple signals by performing a bit-wise addition on the respective multiple signals to perform a carry update in a first direction.

6. The accelerating apparatus according to claim 5, wherein the boundary migrator performs the boundary migration by rearranging the individual lattice values at boundary migration positions matched with the positions of the corresponding multiple signals, and generates a result value by adding the boundary migration values in a second direction.

7. The accelerating apparatus according to claim 6, wherein the first computation circuit further comprises:
a first flip-flop configured to perform a retiming operation on the result value received from the boundary migrator;
a first accumulator configured to accumulate an output value of the first flip-flop; and
a second flip-flop configured to perform an retiming operation on an output value received from the first accumulator and output the retimed result value.

8. The accelerating apparatus according to claim 1, wherein the computation circuit comprises a second computation circuit comprising a plurality of second multipliers configured to generate a result value by perform a computation on the input signal according to a lattice multiplication rule.

9. The accelerating apparatus according to claim 8, wherein the second computation circuit further comprises:
a second accumulator configured to perform an addition on the result value; and
a third flip-flop configured to perform a retiming operation on the result value from the second accumulator and output the retimed result value.

10. The accelerating apparatus according to claim 1, wherein the input signal comprises a first input signal and a second signal,
wherein the computation circuit comprises:
a third multiplier configured to perform a lattice multiplication on the first and second input signals and output a first result value;
an adder configured to perform the boundary migration and an addition on the first result value from the third multiplier to generate a second result value; and
a fourth flip-flop configured to perform an retiming operation on the second result value and output the retimed second result value.

11. The accelerating apparatus according to claim 10, wherein the adder performs a counting function and controls computation logic for the first and second input signals to be repeatedly performed a set number of times.

12. The accelerating apparatus according to claim 10, wherein the computation circuit further comprises:
a fifth flip-flop configured to transfer the first input signal to a first another computation circuit adjacent thereto;
a sixth flip-flop configured to transfer the second input signal to a second another computation circuit adjacent thereto;
a multiplexer configured to output any one of the second result value from the fourth flip-flop and a result value from the first another computation circuit; and
a seventh flip-flop configured to output the result value from the multiplexer.

13. The accelerating apparatus according to claim 1, wherein the computation circuit performs a multiplication on each of the multiple signals derived from the input signal, using any of lattice multiplication, Booth multiplication, Dadda multiplication and Wallace multiplication.

14. An operating method of an accelerating apparatus for a neural network, comprising:
deciding a computation mode according to precision of an input signal;
changing or maintaining the precision of the input signal according to the decided computation mode;
selecting one or more operations among multiple operations including a multiplication based on the input signal, boundary migration to rearrange multiple signals divided from the input signal, and an addition of the input signal subjected to the boundary migration, according to the computation mode; and
performing the one or more selected operations on the changed input signals.

15. The operating method according to claim 14, wherein the changing or maintaining of the precision comprises:
dividing the input signal into the multiple signals, each having a smaller number of bits than the number of bits in the input signal, according to the computation mode; and
outputting the multiple signals.

16. The operating method according to claim 15, wherein the dividing of the input signal comprises
dividing bits of the input signal in half.

17. The operating method according to claim 15, wherein the
performing of the one or more selected operations comprises the steps of:
performing a computation on the multiple signals whose precisions have been changed, according to a lattice multiplication rule; and
performing the boundary migration and an addition on the computation result.

18. The operating method according to claim 17, wherein the performing of the computation on the multiple signals comprises:
performing a bit-wise AND operation on the multiple signals; and
generating individual lattice values for each of the multiple signals by performing a bit-wise addition on the respective multiple signals to perform a carry update in a first direction.

19. The operating method according to claim 17, wherein the performing of the boundary migration and the addition comprises:
performing the boundary migration by rearranging the individual lattice values at boundary migration positions matched with the positions of the corresponding multiple signals; and
generating a result value by adding the boundary migration values in a second direction.

20-21. (canceled)

22. An apparatus for a neural network comprising:
an input processor suitable for receiving an input signal corresponding to an n×n lattice, and processing the input signal to generate multiple signals respectively corresponding to (n/2)×(n/2) sub lattices of the n×n lattice; and
a computation circuit suitable for performing a lattice multiplication on each of the multiple signals, and performing migration on multiplication results thereof to generate a multiplication result corresponding to the input signal.
